(19) United States
(12) Patent Application Publication
(10) Pub. No.: US 2024/0156297 A1
(43) Pub. Date: May 16, 2024

(54) Device for Beverage Making

(71) Applicant: ILLIMITEC AB, Stockholm (SE)

(72) Inventor: Marcus Grotenfelt, Stockholm (SE)

(73) Assignee: ILLIMITEC AB, Stockholm (SE)

(21) Appl. No.: 18/281,728

(22) PCT Filed: Jan. 26, 2022
(86) PCT No.: PCT/SE2022/050074

§ 371 Date: Sep. 12, 2023

(30) Foreign Application Priority Data
Mar. 26, 2021 (SE) 2150367-7

(51) Int. Cl. A47J 31/44; A23F 5/26; A47J 31/06; A47J 31/36

(52) U.S. Cl. CPC A47J 31/4403; A23F 5/262; A47J 31/0663; A47J 31/3671

(57) ABSTRACT

A device and method for distributing and tamping a ground, beverage making substance, particularly coffee, held in a compartment, as part of a process for making a beverage by passing liquid under pressure through the ground beverage-making substance. The device includes a distributor for evenly distributing the ground substance in the compartment by rotation of the distributor; a tamper for tamping the ground beverage making substance by moving the tamper in a tamping direction, and applying pressure on the ground substance; and at least one driving means. The tamper and distributor are directly or indirectly attached to one another and are concentrically arranged and are configured to be brought into contact with the ground substance from the same direction.

### CROSS-REFERENCE TO RELATED APPLICATION

This application is a national stage application, filed under 35 U.S.C. § 371, of International Patent Application No. PCT/SE2022/050074 filed on Jan. 26, 2022, and Swedish Patent Application 2150367-7 filed on Mar. 26, 2021, which are incorporated by reference herein in their entirety.

### TECHNICAL FIELD

This disclosure relates to the making of beverages in general, in particular to the making of beverages under pressure, notably espresso making. In particular, it relates to the steps of evenly distributing and compacting (tamping) the ground coffee powder.

### BACKGROUND

Espresso, the making of a special type of coffee where hot water is pressed through coffee powder under high pressure, has existed for some time. Sometimes Angelo Moriondo of Turin is considered the first in 1884, but many improvements have been made since.

Today the process of making an espresso can typically be divided into four steps: grinding and dosing, distributing, tamping and pressing water through the tamped coffee powder. All these steps, among other things, will significantly affect the flavor and general quality of the beverage produced.
1. Level of grinding, that is how finely ground the beans are, will have significant effect on flavor. Too coarsely ground coffee beans will allow the water to run through the ground powder too fast, making the powder insufficiently extracted and the espresso lacking in flavor. Too finely ground coffee beans can result in overextraction and the water barely being able to pass through the portafilter (the compartment, strainer or filter in which the ground coffee is stored during the espresso making process). The resulting beverage is a small amount of bitter coffee. An added difficulty is that optimal grinding level also depends on the freshness and roast level of the beans. Fresh or lightly roasted beans are moist and should not be ground as finely as older, drier beans. The dosing, that is the amount or weight of coffee beans ground and put in the portafilter, also affects the resulting espresso. With a high dosage the ground beans should not be compressed too much in the later steps. Alternatively, it could be more coarsely ground.
2. Distributing the ground beans in the portafilter is a step that does not seem obviously necessary. In some cases, it is indeed skipped, but experience or consideration of the physical process show that failure to take this step will negatively affect the beverage produced. Due to the laws of physics, when the ground beans are put in the portafilter, the powder ends up in the shape typical for a heap, a structure reminiscent of a hill, highest in the middle, lower at the edges. If one skips the second step of distributing this powder and immediately proceeds to the next step in which the powder in the portafilter is tamped (pressed) right away, it means that the tamped powder will have the highest compactness and density in the middle and a lot less at the edges. Fluids, including water, flows through the path of least resistance and, in this case, it means the water flows through mostly near the edges resulting in the densely packed powder in the middle being insufficiently extracted and the less densely packed powder near the edges being over-extracted. A combination of insufficient extraction and excessive extraction is not the same as evenly sufficient extraction. The beverage produced by such a combination of insufficient extraction and excessive extraction is generally considered much inferior in flavor to the beverage produced by evenly sufficient extraction. The worst case is that one or more “tunnels”, microchannels, are created near the edge of the portafilter making the powder barely extracted at all resulting in a very thin and watery product.
3. The next step is tamping, that means pressing the ground beans so that they are compressed and form a “cake” further helping to create an even extraction of the ground coffee beans. A rule of thumb in modern professional espresso making is to use a pressure of roughly 10 kg that is around 100 N. However, optimal pressure varies with what type of beans are used and how fresh they are. If the beans are very fresh, very little pressure is needed. Espresso is defined by the brewing method, not the type of bean. Thus, bean blend, roast level, freshness or the coarseness of the ground beans can vary, you might even use some other powder than coffee beans to create espresso. Many different types of ground beans are therefore possible each requiring a different force for optimal tamping.
4. Pressing water through the tamped coffee powder is typically done at around 900 kPa and 88° C. In modern machines pressure and temperature can be selected. These settings result in different percolation times. Generally, the more densely packed the powder is (due to tamping and how finely ground the coffee is) the more time it takes for the water to pass through.

These four steps affect each other and the beverage produced greatly. For instance, fine grinding goes best with low force tamping in order to avoid overextraction, a tightly tamped powder might require higher water pressure to allow water to pass through properly. An almost endless number of combinations is possible when making an espresso. This allows for adjustability but can make it hard to produce a consistent and predictable result, particularly if the operator is inexperienced.

To execute the second step something called levelers or distributors is available. They are turbine-shaped and are put on the edge of the portafilter. It is then spun a few revolutions and the beans are thus distributed. A problem is that it often fails to distribute properly and it is often difficult to avoid some tamping happening at this stage. Thus, in some cases, particularly with fresh and finely ground powder, no third step, tamping, is performed after this. The result is sometimes considered sufficient without that step. However, this is unsatisfactory, particularly if working with coarse ground or powder of not so fresh ground beans. Occasionally the leveler or distributor is sometimes used for some tamping too. This is unsatisfactory since a lower surface must be somewhat uneven for distributing, leveling or stirring to occur, but a lower surface for even tamping must be even to evenly compress the entire area. Another disadvantage is that if the lower end of the tamper/distributor is partially open (which can be desirable for good distribution) it makes it possible for ground coffee to enter the inner parts of the machine.

The greatest problem today is the third step, tamping. Existing tampers are basically a round plate of a diameter to fit the portafilter with a handle for the operator to press to tamp the ground beans into the portafilter. It is difficult for a human to exert the same exact force every time so espressos made by the same person using the same ground beans powder and the same machine might vary. The difference between different people is of course greater. Also, it is difficult to tamp in such a way that the surface of the “cake” is properly horizontal particularly if distribution has not been done properly in the previous step. Proper horizontal tamping requires that the tamping lower surface of the tamper is horizontal and this in turn requires that the operator can hold and press at a perfectly perpendicular angle to the bottom of the portafilter—in practice this means to press down in a perfectly vertical way. This is difficult for humans to do particularly if they are stressed and tired after working long hours standing up. These are problems particularly for major chains like Starbucks, that desire to make an espresso of high and consistent quality, no matter where in the world it is served. The problems can be alleviated with proper training, but that entails cost and makes replacement of operator harder and more expensive.

Prior art includes:

WO2020084436 is a tamping device without any distributor where the tamper rotates after tamping to avoid coffee powder sticking to the tamper. The purpose of the rotation is not distribution but removal of coffee powder from the tamper.

EP1126774 is an espresso making device that tamps by a helical motion of the tamper, but has no separate distributor. For this purpose, the lower end of the tamper is not flat.

AU2017245364 is like EP1126744 tamping by helical motion of the tamper, no separate distributor. Since they use the same tool for tamping and distribution (as it states in the first claim) the lower end of the tamper/distributor is not flat resulting in a less than perfectly even “cake”. Another disadvantage is that the lower end of the tamper/distributor is partially open, making it possible for ground coffee to enter the inner parts of the machine.

WO2020052348A1 on the other hand has a separate distributor (stirring device 50) that works separately from below while the tamping device (filter-press assembly 40) works from above making the tamping and distribution two completely separate processes. The downside with this solution is that the stirring device is semi-permanently disposed inside the filter; (only independent claim: “The stirring device is disposed in the filter-press chamber, and the stirring device is not in contact with the filter-press assembly;”). This means that you must either detach it in some inconvenient way (magnetism is suggested) separately from the removal of the tamper or pass the water through the filter with the distributor still inside the filter. Stirring from below is also a more difficult way of creating an even upper surface than stirring from above.

WO2020257869A1 suggest a different form of separate distributor solution where distribution is done by shaking or vibrating the portafilter or the coffee bean powder within. This of course is a completely different solution with all the disadvantages of two separate solutions, the added complexity of adding a shaking machine and the added problems that vibrations can cause.

Thus, separate distributor and tamper are preferable for creating an even “cake” with essentially constant density throughout. However, a single tool has a great advantage in ease of use and thus saving time, which is very useful during peak hours. It also avoids the problem with having to remove the distributor after distribution, an operation that is likely to disturb the even surface created by the distribution. The problem with making one single tool for distributing and tamping is that you sacrifice the efficiency of either or both the distribution and tamping. Specifically, an uneven lower surface is required for distribution/stirring (otherwise it won't stir) but an essentially even, flat surface horizontal and parallel to the essentially flat upper surface of the distributed ground coffee is required for optimal tamping (otherwise it won't tamp evenly). A surface can obviously not be even and uneven at the same time.

It is therefore desirable to have a solution that combines the advantages of these methods. This solution should evenly distribute the ground coffee in the portafilter and then tamp the ground coffee with a properly horizontal surface essentially parallel to the upper essentially flat surface of the ground coffee in the portafilter in a consistent way without requiring the operator to switch tools or otherwise cause delay. Tamping should not be physically demanding. The tamping should preferably be consistent even between different operators, even with a relatively untrained operator. Also, it should be consistent but adjustable when so desired. This adjustment should yield predictable results. Currently, a quality-conscious professional barista will often produce and taste multiple cups of coffee with the same settings to get the adjustment right to exclude the variation in tamping. The tool should be easy to put on and remove from the portafilter.

### SUMMARY

These advantages can be achieved by having a single assembly including both distributor and tamper that are concentrically arranged. This can be done, for instance, by placing distributor and tamper on a single axle. If tamping is done downwards, as is preferable, the single assembly is placed above and possibly on the portafilter containing the ground powder. Within the single assembly, the tamper would be placed essentially above the distributor during distribution and moving down, at least partially through the distributor, to tamp. This results in a very even cake with an essentially flat horizontal upper side and an even density throughout the cake.

This solution requires that the tamper can somehow, loosely speaking, “pass through” the distributor and/or “merge” with the distributor. This can be achieved by designing a distributor and tamper that fit so that they can pass into and/or through each other. The distribution and tamping can be driven in one same, single movement, preferably a single, pumping, downward movement. However, separate driving for distribution and tamping are also possible, especially in highly automated embodiments.

The force is preferably adjustable by a simple setting so higher or lower density can be achieved. It is, in some embodiments, pressed towards the edge of the portafilter like a traditional leveler, but distributes the beans without compressing them. Immediately after this they are tamped in the same single movement.

This means that step 2 and 3 are done with suitable surfaces but without delay and trouble to switch tools.

### BRIEF DESCRIPTION OF THE DRAWINGS

FIG. 1-7 shows how the invention is intended to be used as a sequence of figures.

FIG. 1 shows the invention immediately prior to use.

FIG. 2 shows the invention when the portafilter with ground coffee is brought in contact with the invention

FIG. 3 shows the invention when the distributor is distributing, but tamper has not yet tamped.

FIG. 4 shows the invention after distribution and tamping.

FIG. 5 shows the invention with locking means activated.

FIG. 6 shows the invention disengaged from the portafilter.

FIG. 7 shows the button released locking means disengaged,

FIG. 8 shows the invention seen slightly from below in compressed state.

FIG. 9 Shows the construction details of the same embodiment as in FIG. 1-8.

FIG. 10 Shows a second embodiment, different from the one in FIG. 1-9.

FIG. 11 shows a third embodiment, which is essentially the second embodiment in FIG. 10 mounted on a rod and lever for ease and accuracy of handling.

FIG. 12 shows a fourth embodiment, in which the rotating movement of the distributor and the downwards movement of the tamper are driven by a separate driving axle.

FIG. 13 shows a flat sideview and a three-dimensional view of the same one possible mechanism for preventing undesired rotation of the distributor.

### DETAILED DESCRIPTION

### Legend for the Figs

1: Body (and contacting means between embodiment and portafilter)
2: Spring for the locking mechanism
3: Locking mechanism
4: Handle
5: Axle for rotation of the distributor
6: Spring for the handle
7: Body “holder”.
8: Tamper
9: Distributor
101: Hole for the handle (4).
102: Threaded surface.
103: Inner surface of the body, at least partially threaded
104: Underside of the body, works as contacting means in this embodiment
301: Button for the locking mechanism
302: Square shape to hinder rotation of the button mechanism (3)
303: Underside of the button mechanism designed to lock rotation of (5) when pressed downward.
401: Hole for (303).
402: Threads on the inside of the handle.
403: Inner diameter of the lower part of the handle. Needs to fit the spring (6).
404: Opening in the handle for part 702.
405: Hole inside handle, for part 301.
406: Square-shaped hole inside handle to hinder rotation of part 5.
501: Top of part 5. Lock rotation of part 5 when in contact with (303).
502: Horizontal axle on part 5.
503: Rod (to fit part 6)
701: Hole with the same diameter as the diameter of part 503.
702: Beam through 404.
703: Threaded surface.
801: Hole through tamper.
802: Grooves, opening or indents matching the blades (903) of the distributor.
803: Underside of tamper.
901: Hole on the top of (902) matching the diameter of part 503.
902: Rod.
903: Distributing “blades”.
904: Underside of the distributor.
10: Embodiment 1 from the front in outstretched position.
11: Embodiment 1 from the top in outstretched position.
12: Section view of embodiment 1 from the side in outstretched position.
13: Embodiment 1 from the underside in outstretched position.
14: Embodiment 1 in compressed position.
15: Portafilter.
31: Lever
32: Upper catch for part 35
33: Lower catch for part 35 (threaded on the inside of part 34 to adjust how far into the portafilter it goes)
34: Rod on which the lever is attached
35: Somewhat modified version of 7, body holder, downward movement is limited by part 33 instead of the body as in embodiment 1 and 2.
36: A version of embodiment 2, adapted to be mounted
1301: Button for locking mechanism
1302: Button frame, holding the button (1301).
1303: Actuating rod for transferring the movement from the button (1301) to the axle (1304).
1304: Axle in the figure shown to lock vertical movement of (1306) Distributor rod.
1305: Locking device attachment, attaching the entire locking mechanism to e.g. the inside of the handle (4).
1306: Distributor axle attached on distributor (9).

### DETAILED DESCRIPTION OF THE FIGURES

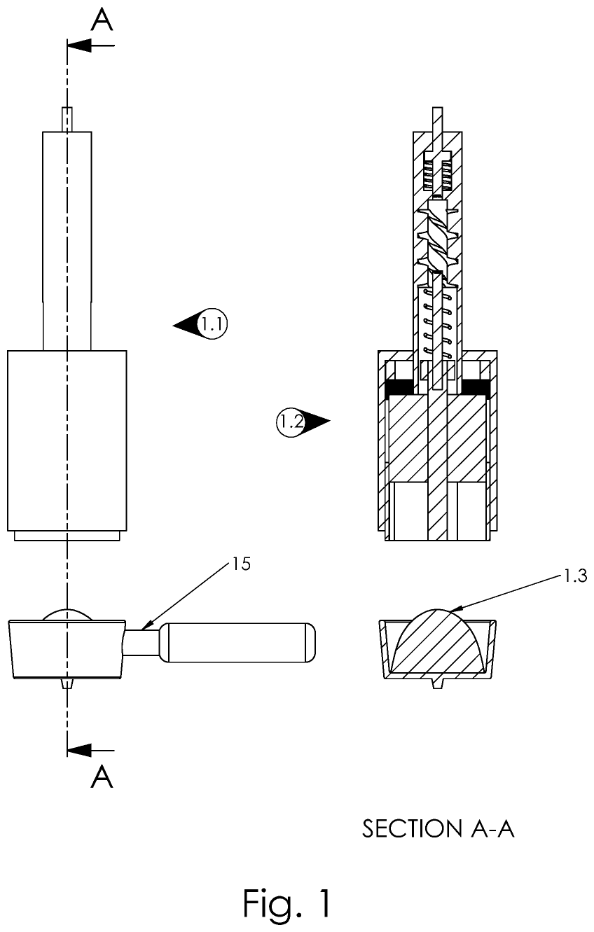

FIGS. 1-7 are intended to show one way of using one embodiment of the invention as a series of sequential figures showing the invention and the portafilter with ground coffee it is meant to work on prior to use, contacting, distribution, tamping and disengagement. The same embodiment is shown in all these figures. The step of locking and unlocking rotation shown in this sequence is not a feature in all possible embodiments of the invention.

FIG. 1 shows an embodiment of the invention immediately prior to use and the portafilter with ground coffee in a heap to be distributed and tamped by the invention.
1.1: Embodiment 1 in outstretched position,
1.2: Section view of 1.1 and
1.3: ground powder in portafilter.

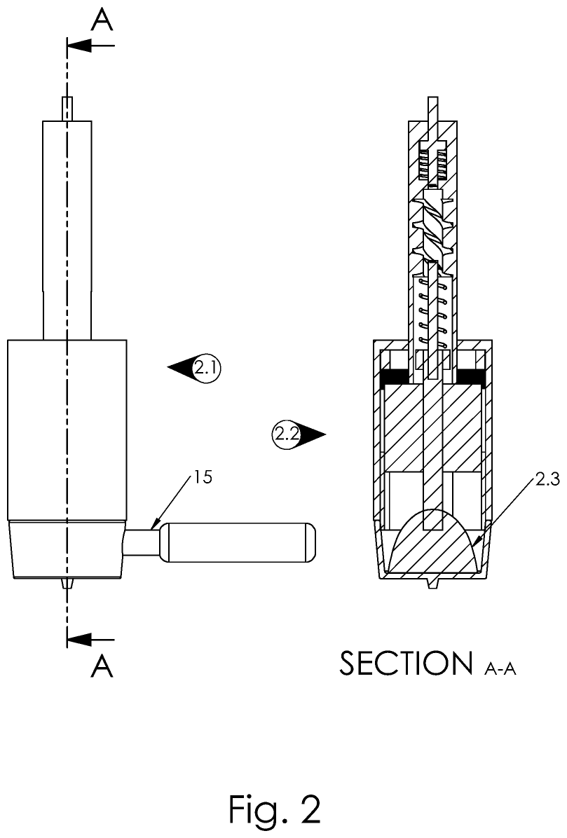

FIG. 2 shows the same embodiment of the invention when the portafilter with ground coffee is brought in contact with the invention but before the distribution and tamping. Note that the ground coffee powder is still in a hill-like heap.
2.1: Embodiment 1 in outstretched (i.e. tamper up) position.
2.2: Section view of 2.1.
2.3: Ground powder in portafilter

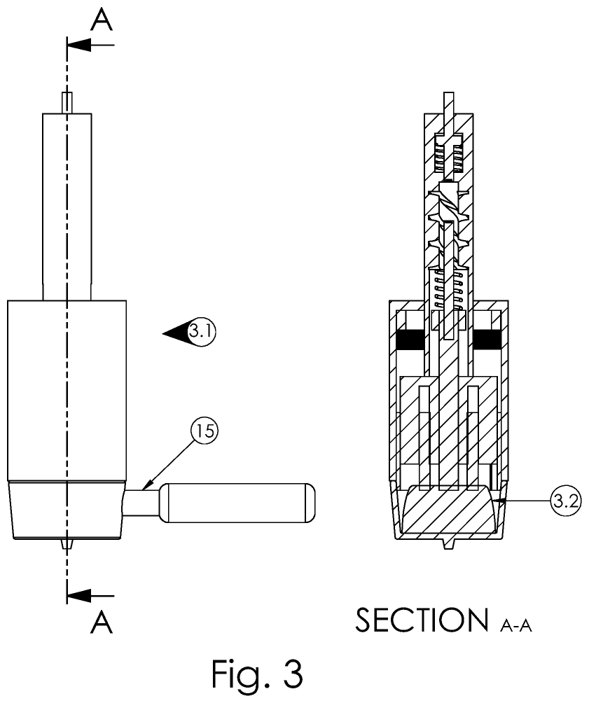

FIG. 3 shows the same embodiment of the invention when the distributor is distributing and the tamper is moving down but has not yet reached the ground coffee powder and has not yet tamped the ground coffee powder.
3.1 Embodiment 1 during distribution.
3.2 Ground powder in portafilter being distributed but is not yet tamped.

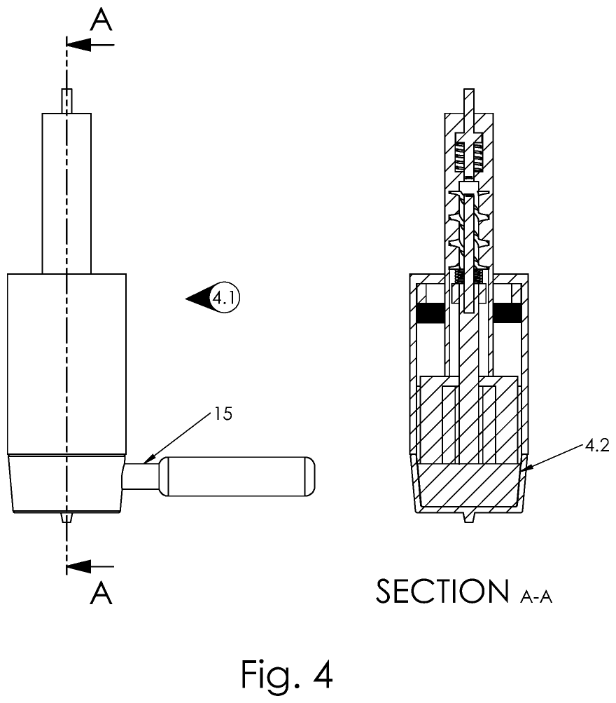

FIG. 4 shows the same embodiment of the invention after distribution and tamping
4.1: Embodiment 1 in compressed (i.e. tamper down) position.
4.2: Distributed and tamped powder in portafilter.

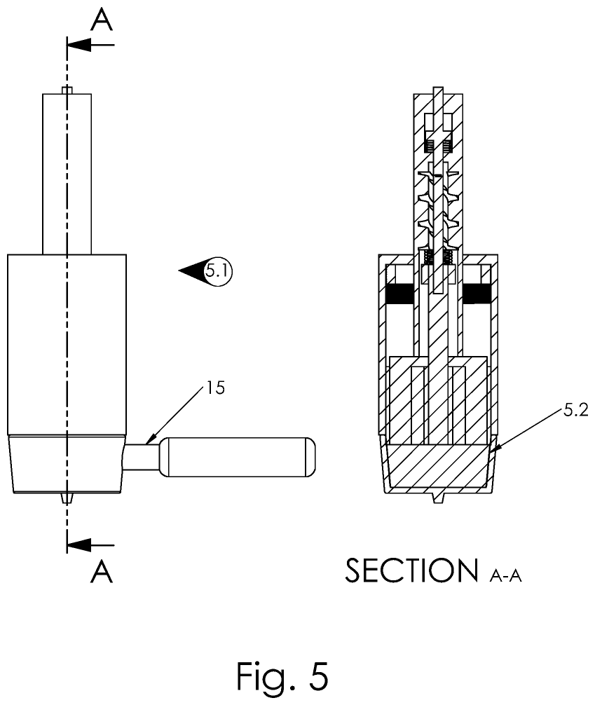

FIG. 5 shows the same embodiment of the invention with locking means activated locking the rotation of distributor. Note that not all embodiments of the invention feature the locking mechanism and locking step.
5.1: Embodiment one in compressed position with the button (on top in FIG. 4) being pressed down, locking the rotation of the distributor.
5.2: Distributed and tamped powder in portafilter.

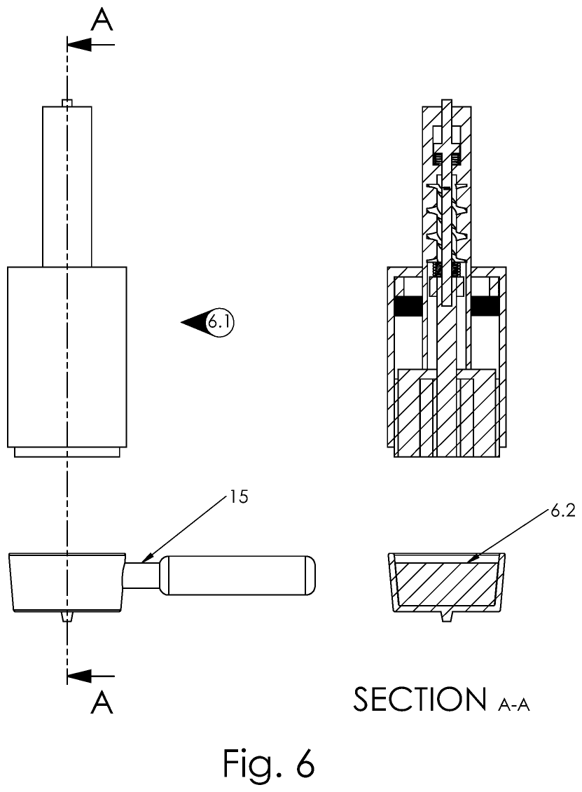

FIG. 6 shows the invention disengaged from the portafilter with rotation of the distributor still locked. The process of distribution and tamping is complete and the portafilter is ready to be used for pressing water through it for espresso making.
6.1: Embodiment 1 in compressed position. Button pressed down.
6.2: Distributed and tamped powder in portafilter

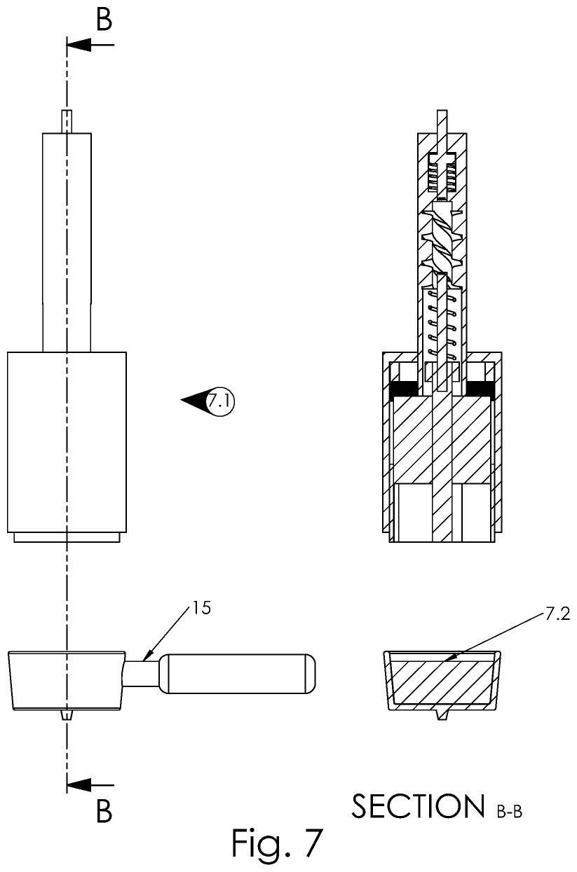

FIG. 7 shows the button released locking means disengaged, the invention returning to outstretched position and ready for use again. Note that not all embodiments feature a locking mechanism and an unlocking step.
7.1: Embodiment 1 in outstretched position. Button released.
7.2: Distributed and tamped powder in portafilter

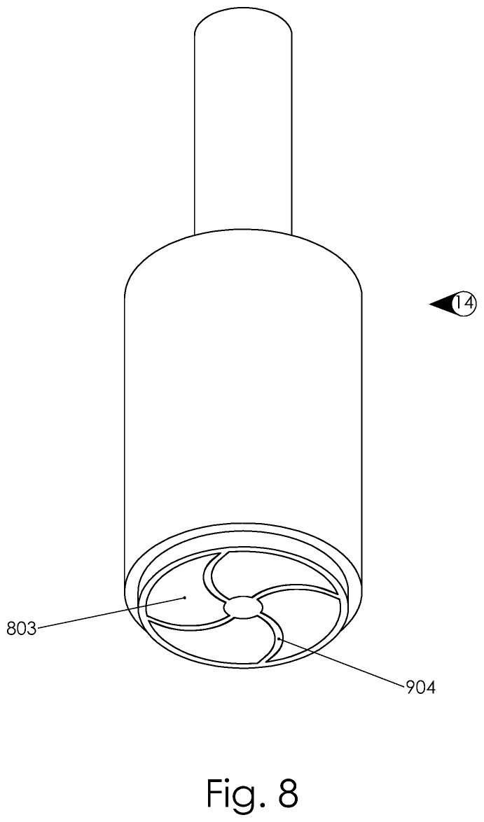

FIG. 8 shows the invention seen slightly from below in compressed state, corresponding to FIG. 4-6 in the sequence FIG. 1-7. Note that the lower surface formed by the distributor and tamper together in the compressed state form an essentially even, horizontal surface as of claim 2. Since the ground coffee powder in the portafilter has been distributed fairly evenly by the distributor the ground coffee in the portafilter also has a similarly fairly even, horizontal surface Thus, during tamping, one fairly even, horizontal surface, meets another essentially horizontal surface. This results in a better, more even tamping and creates a tamped cake of ground coffee with even density throughout the cake. The upper surface of the cake has also been further improved and is more horizontal and more even than the fairly horizontal and even surface created by the distributor. These improvements to the tamped cake will eventually result in a coffee beverage of higher quality.

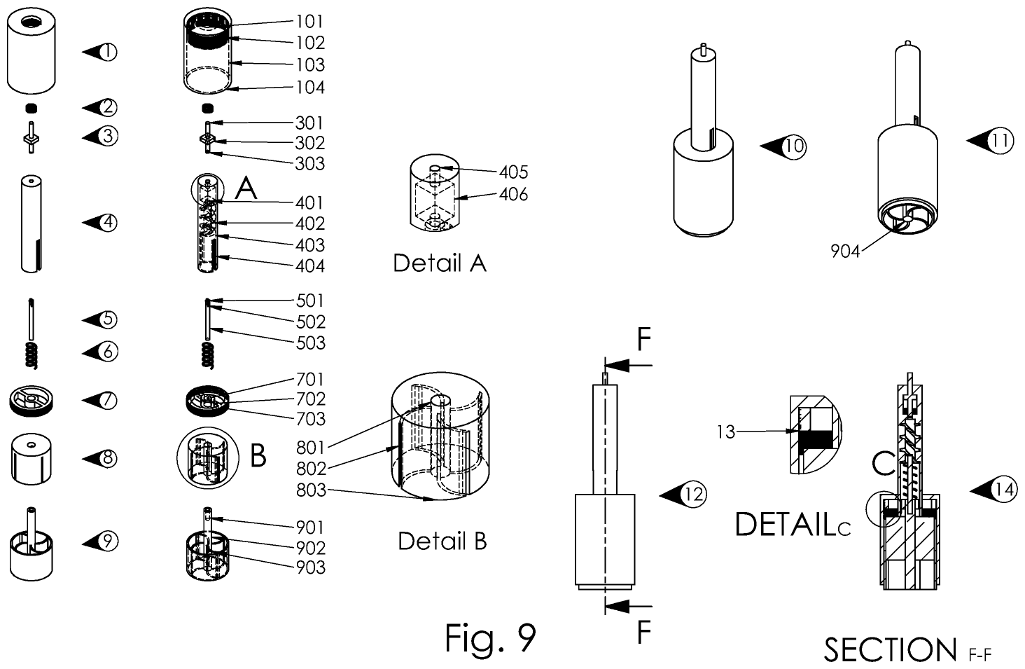

FIG. 9 Shows the construction details of the same embodiment as in FIG. 1-8. Note that in this embodiment the adjusting device of claims 7-9 are in this case formed by threads on inside body (102) and outside of body holder (7).

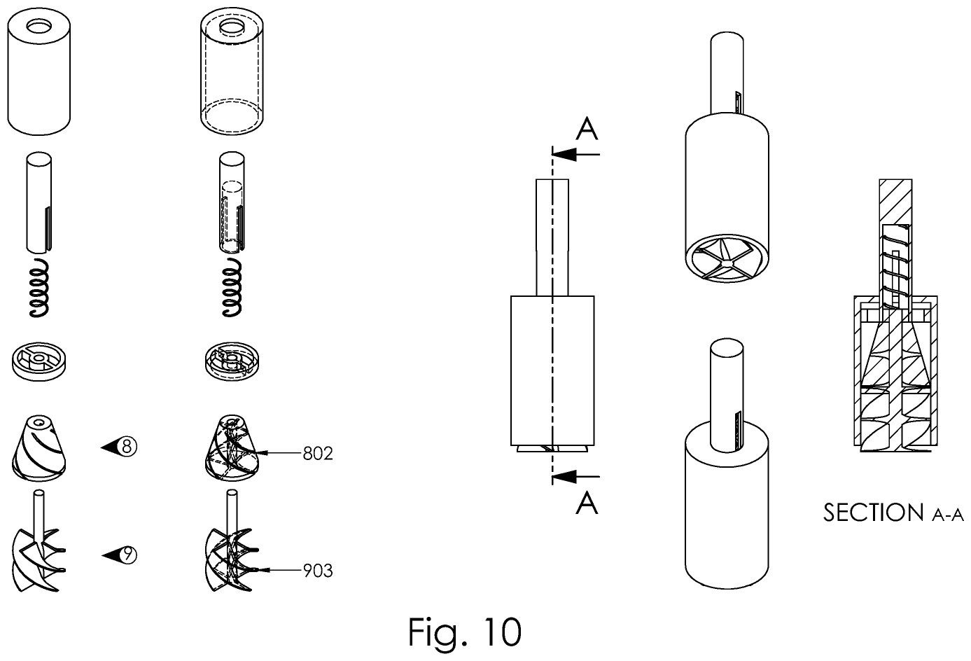

FIG. 10 Shows a second embodiment, different from the one in FIG. 1-9. It differs from the first embodiment in that the grooves in the tamper are helical. This allows rotation of the distributor to be created directly by the downward movement of the tamper. The blades of the distributor enter the grooves of the tamper and the downward movement of the tamper brings the distributor to rotate by reverse screw principle.

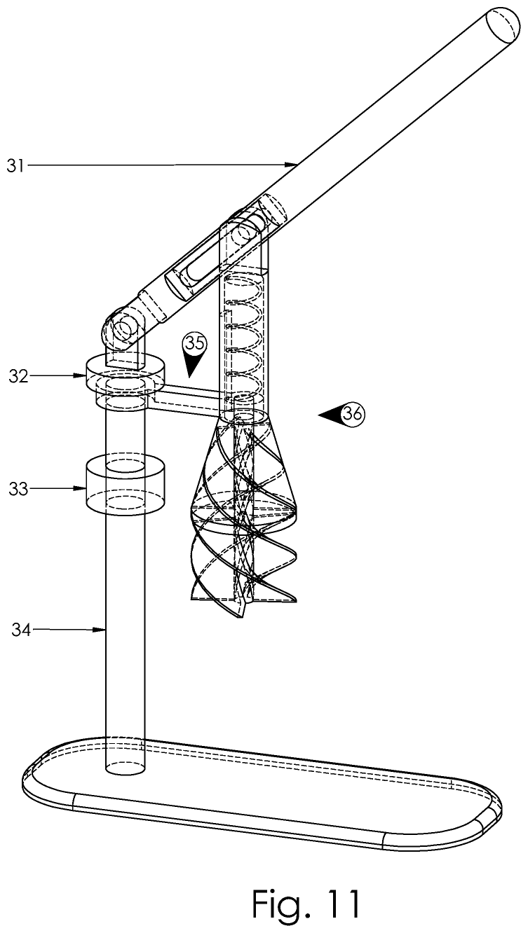

FIG. 11 shows a third embodiment, which is essentially embodiment 2 in FIG. 10 mounted on a rod and lever for ease and accuracy of handling. This embodiment also has a different way of realizing the adjustment device.

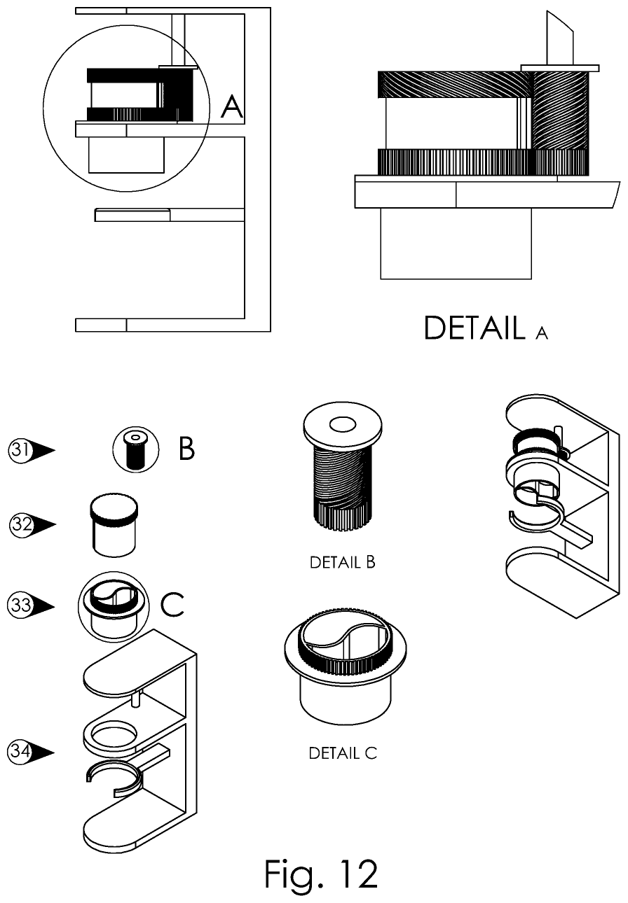

FIG. 12 shows a fourth embodiment, a driving axle on the side of the distributor and tamper rotates causing the distributor to rotate and the tamper to move down. This embodiment is more suitable for driven, powered and more automated solutions.

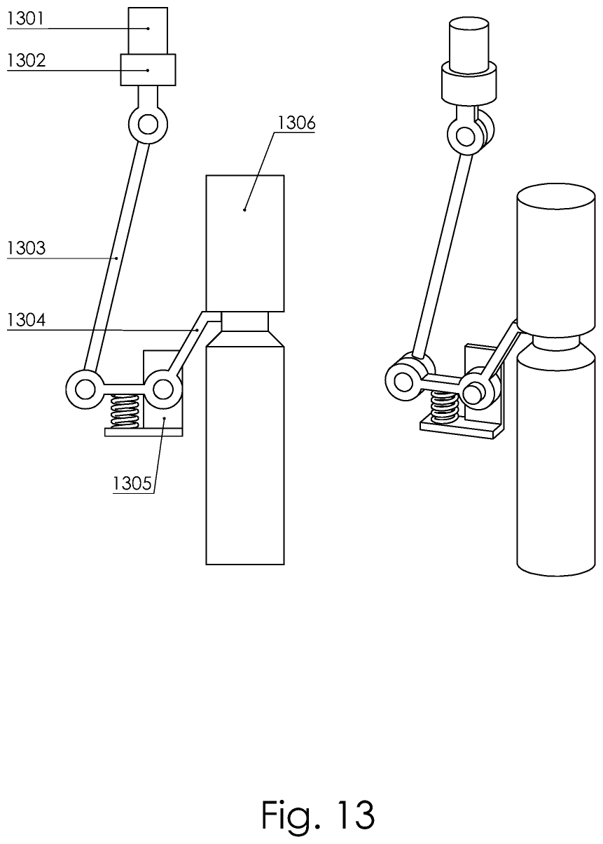

FIG. 13 shows two views of one locking mechanism, flat side view and three-dimensional view of the same mechanism, one of many possible ways to prevent undesired rotation of the distributor. When the distribution and tamping is done it is desirable to prevent further movement of the distributor until it is moved away from the tamped surface. Otherwise, it will disturb the smooth, even surface of the tamped material. Another advantage with such a locking mechanism is that it reduces the risk of ground coffee entering the interior of the device. In the depicted solution the distributor and tamper are locked until a button is pressed. The operator uses the device for distributing and tamping, the locking mechanism locks tamper and distributor, the operator then removes the device and presses the button to release the tamper and distributor returning them to the original, unlocked state.

The distributor works by rotation, but the rotation can be created in many ways. One way is to have the downward movement drive the rotation. A reverse screw can cause rotation when moved downwards. Embodiment 2 in FIG. 10 works by reverse screw principle using grooves on the tamper to act on the blades of the distributor. An internal screw, that is threads on the inside of the shaft can cause rotation. The idea being that a minor axle is perpendicular to the distributor's axel in the threads causing the distributor to rotate when the handle I pressed down. Another way of making the distributer rotate by internal threads is to have threads on the inside of the body. Abutments on the upper part of the tamper, extending perpendicularly to the distributer's axel, cause the abutments to move along the threads on the inside of the body and make the distributer rotate. In all three of these cases the handle should be biased back by some sort of biasing means. Particularly in the last case, with threads on the inside of the body, a locking mechanism to prevent unwanted rotation of the body in relation to the body holder is highly desirable. Rotation can of course also be created by having the operator rotate an actuator or by one or more motors.

Other methods and means, powered and manual, are of course possible.

The number of blades in the distributor is not set. The number can vary between different embodiments. It depends on the how much distribution is necessary and how many revolutions is convenient. If for one reason or another it is impractical to implement many revolutions, the number of blades can be increased instead. Note that it is possible that the number of revolutions is less than one, for instance 180°. The shape and/or angle of blades can also differ between embodiments. Depending on how many revolutions are needed the shape of the blades decides how quickly the ground bean heap is distributed towards the sides of the portafilter. However, generally speaking, it is desirable that the distributor makes at least one complete revolution regardless of the number of blades. Otherwise, the ground coffee beans can end up on one side in the portafilter, particularly if the “heap” is not centered in the middle of the portafilter.

The axle (5) for rotating the distributor can be produced as a single item or as two or more items that are assembled. It can be hollow or massive. It does not have to be symmetrical or uniform along its entire length. It could, for instance have a radius that varies along its length. The axle could also be completely integrated with the distributor and made as a single item as in embodiment 4 FIG. 12.

In many embodiments a locking mechanism is implemented so the distributor stops moving when the tamper has reached the end or is near the end of its downward movement. One possible way of implementing such a locking mechanism is shown in FIG. 13. This allows for the invention to be removed from the portafilter while retaining a smooth lower surface. Otherwise, the distributor would start rotating the other way and possibly ruin the even surface when the invention is being removed. Two advantages are achieved by this: the smooth lower surface does not interfere with the nice, even tamping created and it significantly reduces the risk of ground coffee entering the inner parts of the mechanism. The locking mechanism can be implemented with an automatic/internal locking when the tamper has reached the end of its downward movement and a manual/external release to make the invention ready for new use. Such a locking mechanism is illustrated in FIG. 13. However, the locking mechanism can also be implemented to be both locked and released manually/externally.

In any embodiment it is possible to make the distributor and tamper, when they are on the same level (when distribution is done), push down just a bit further to ensure that the surface isn't ruined when the device is removed from the portafilter. This can be implemented by using a spring mechanism, with a higher force needed for compression than the other spring mechanisms used in the device, placed so that it does not affect other moving parts in relation to each other, but the whole device.

In many embodiments how far down into the portafilter the ground beans are tamped, that is how far down the tamper moves, is adjustable. Such adjustability can be implemented in many ways, such as by moving the body of the device vertically in relation to the distributor. One way to achieve this is to have threads on the inside of the body and on the outside of the body holder. The operator adjusts by rotating the body in relation to the body holder to the desired setting. When adjustment is implemented in that way it is desirable to prevent undesired rotation of the body in relation to the body holder (7) and thus undesired changes in the setting. This requires some sort of locking mechanism. One possible way is to make changes to the body. The top part, the “roof” or “lid”, of the body is removed making the body open in both ends, shaped like a cylinder or truncated cone. Instead, a lid to the body, fitting partially on and partially inside the upper part of the body, fits into the handle in a way that prevents rotation, (for instance the same way the body holder fits into the handle in FIG. 9 but preferably fitted above the body holder).

This lid has vertical (i.e., perpendicular to the rotation, parallel to the axis of the rotation) grooves mounted on the outside of the lower part of the lid, the part of the lid that goes into the body. There would need to be matching, vertical grooves on the inside of the upper part of the body. When inserted into the body, grooves on the outside of the lower part of the lid (the part that goes into the body) and grooves inside of the upper part of the body grip each other and prevent rotation of the body.

In embodiment 3 FIG. 11 it is implemented by a lower catch (33) for the body holder (35). This lower catch (33) is placed on a rod (34) in a way that allows a user to change the position of the lower catch (33) on the rod (34) and thus adjusting tamping.

In many embodiments it is desirable to have a contacting means to establish contact between the portafilter and the invention, particularly embodiments intended to be manually operated by a human operator. This contact allows correct distance and position so distributing and tamping happens at the right height and right angle and also putting the portafilter and the invention in a proper concentric fashion. The contacting means can also serve the purpose of steadying the portafilter and the invention. In the figures, the contacting means (104) is simply the lower edge of the body with a radius that matches that of the portafilter. However, we can also imagine a contacting means where the profile of the inventions contacting means, when seen from a direction perpendicular to the radius, matches the corresponding profile of the portafilter such as an abutment on the upper edge of the portafilter fitting into a groove in the contacting means. Contacting may also be releasable fastening with fastening devices.

In embodiments where the invention is directly handled by a human, as opposed to embodiments where the human operator, for instance, just pushes buttons, a handle intended for human grip is desirable.

In embodiments where the invention is directly handled by a human, it is also desirable to have an outer hull, mantle, body or cartridge corresponding to (1) in the figures for protecting the inner parts from ground coffee beans powder that could get stuck and cause trouble. It is also desirable for the reason of preventing damage caused by fingers, pieces of skin or hair getting stuck. It is desirable that this hull, mantle, body or cartridge is removable for repair or cleaning. The hull, mantle, body or cartridge might not be necessary if the invention is part of a larger machine and already encased in the hull of the machine.

The invention can be put on a lever for ease of handling as is the case in embodiment 3 in FIG. 11. This has the advantage of making tamping and other steps in the process require less force and the necessary movements can be done with more accuracy. This might be particularly desirable for an embodiment intended to be directly operated by a human operator. In FIG. 11 the lever is further mounted on a rod, but this is not necessary. As FIG. 11 shows with a rod and lever, the adjustment device can be realized in a way that differs from the first and second embodiment. (33) lower catch stops body holder (35).

The invention can be a relatively simple mechanical tool operated by a human operator and powered by the operator's muscle strength (plus gravity perhaps since it is by far easiest to tamp downwards). However, much more automated embodiments are possible. For instance, the distributor and/or tamping can be machine powered by one or more motors. The invention can also be part of an espresso machine with an automatic bean grinder so the machine grinds, distributes and tamps the beans. In such a machine, the same electrical motor or other driving means could be used for all of the processes of grinding, distributing and tamping. Such an automated embodiment could have many settings for amount of ground coffee, how finely ground the coffee should be, how much the ground coffee should be tamped and how much pressure should be applied when passing water through the ground coffee powder. For most users it would be preferable to just tell the machine what the desired result was, and the machine take this input, and possibly such facts as the type of beans used and the roast level of the beans used and the quality of local water and calculate the best settings for level of grinding, amount of coffee powder, level of tamping, pressure of water, etc. In a more automated embodiment, like the one described above, contacting means like the one in embodiment 1 body holder (7) is less of a necessity than in embodiments where the invention is a relatively simple, human-powered, mechanical tool. Contacting means could be replaced by a “portafilter fastener” where you fasten the portafilter directly under the distributor/tamping device, then regulate how far down into the portafilter the device will distribute/tamp inside the machine above. The threads on the inside of the bodyholder (7) could be replaced with threads on the inside of the machine instead.

The invention can be manufactured in many ways including, but not limited to 3D-printing, stamping, casting and injection molding. Many materials could be used, including but not limited to metals, plastics and composites such as kevlar. There is no particular reason to use the same type of material for all parts of the invention, nor is there a reason that any single part can't be made in two materials, for instance an inner material more suitable for being an inner material coated with another, outer material more suitable for being the outer material. It is highly desirable that the invention is manufactured in such a way and with such materials that lubricants are not necessary in any area near the coffee or water or where the lubricants might reach the coffee or water. It is also desirable that the tolerances between moving parts are smaller than the smallest grains of ground coffee to prevent ground coffee from coming in between the moving parts. This is particularly true for the distributor and tamper.

The invention should withstand at least 300 N+ a suitable margin in vertical direction since some users prefer strong tamping. Materials, manufacturing method and surface treatment should also be chosen while taking into consideration that a professional barista might use it several hundred times a day and will expect the invention to function reliably throughout the day with little maintenance. This ruggedness or reliability should be achieved without making the machine so heavy that it requires significant strength to handle and carry the invention, particularly if it is an embodiment that is intended to be used by a human operator.

Ease of assembly as part of manufacturing and ease of assembly/disassembly as part of repair, maintenance or cleaning is also something that need to be considered when the invention is manufactured. It is desirable that the machine can be disassembled in way that is suitable for washing by dishwasher.

If an embodiment intended for a human operator to handle, grips should be made of materials that are grip-friendly. Parts that get in touch with the ground coffee while in operation should be made in a material suitable for handling substances intended for human consumption. These materials should also be chosen with consideration for how it is desirable to avoid coffee powder sticking to the equipment. Some type of non-stick plastic might be suitable. All materials need to be resistant to humid and wet conditions and easy to clean, preferably both by machine washing and washing/rinsing by hand.

The terms “coffee” and “water” are consistently used throughout the text, for ease of reading, but other types of ground material and other types of liquid suitable for creating a beverage by driving a liquid under pressure through it could also be used with the invention. In the description text, the term “portafilter” is used as this is the most common term used in practice. This should not be construed as limiting the scope of the invention. Many compartments, types of filters and strainers in many materials, forms and shapes might be suitable. Likewise, the term “the invention” used in the description refers to the “device for distributing and tamping a ground, beverage making substance, particularly coffee, held in a compartment such as a filter, portafilter or strainer, as part of a process for making a beverage” of independent claim 1.

To facilitate understanding, terms used in the claims and description referring to orientation, such as “downwards” or “down”, assumes that the invention is held and operated in the normal, most convenient way, so that the portafilter is held essentially horizontally and the tamping is done essentially vertically downwards. It is possible, albeit highly inconvenient, to operate the invention while holding it in a different way. Such terms referring to the orientation should thus not be interpreted as a limitation to the scope of the invention.

It is desirable that the invention can be fully or partially disassembled for purposes such as cleaning, maintenance, repair, examination, shipping or transportation. However, unless otherwise stated, the invention is described and drawn in an assembled, operative state. That is a state where it is in use or ready for immediate use, as opposed to a state where it is fully or partially disassembled for purposes such as cleaning, maintenance, repair, shipping or transportation. This state of being in use or being ready for immediate use is sometimes expressly referred to as “operative state”. However, absence of this phrase should not be interpreted as the invention being in inoperative state, operative state is the default.

The phrase “directly or indirectly attached to one another” used in the first claim refers to the fact that item A and B can be attached to one another by direct gluing, welding or nailing etc, a part of item A “touching” a part of item B, “directly attached”. However, A and B can also be attached to one another by one or more intermediate items. For instance, A can be attached to C and B can be attached to D and C can be attached to D make A and B attached to each other through other items, “indirectly attached”.

The phrase “in operative state the tamper (8) and distributor (9) are concentrically arranged” used in the first claim means that they are concentrically arranged with respect to one another at the same time. It does not refer to a situation where the distributer first takes a first position, then is removed and then the tamper takes a second position where the first and second positions are concentric.

The adjustment device of claims 7-9 are in the embodiments in FIGS. 9 and 10 formed by threads on the inside of the body (102) and outside of the body holder (7). In embodiment 3 in FIG. 11 it is realized by (33) lower catch for (35) body holder. Other ways of realizing an adjustment device are, of course, possible, and known to the person skilled in the art.

Many different embodiments have been disclosed herein, in connection with the above description and the drawings. Features of these embodiments can be combined. For instance, it is possible to mount the invention on a rod and lever like in embodiment 3 while still using the adjustment device of embodiment 1 and 2. We can also imagine an embodiment that can be fitted to a rod and lever like in embodiment 3 but also removed from the rod and lever and used without rod and lever like in embodiment 1 and 2. It will be understood that it would be unduly repetitious and obfuscating to literally describe and illustrate every combination and subcombination of these embodiments. Accordingly, all embodiments can be combined in any way and/or combination, and the present specification, including the drawings, shall be construed to support claims to any such combination or subcombination.

It will be appreciated by persons skilled in the art that the present embodiments are not limited to what has been particularly shown and described herein above. In addition, unless mention was made above to the contrary, it should be noted that all of the accompanying drawings are not to scale. A variety of modifications and variations are possible in light of the above teachings without departing from the scope of the following claims.

1.-14. (canceled)

15. A device for distributing and tamping a ground, beverage making substance, particularly coffee, held in a compartment such as a filter, portafilter or strainer, as part of a process for making a beverage, particularly espresso by, subsequently to distributing and tamping, passing liquid under pressure through the ground beverage-making substance, held in the compartment, the device comprising:
a distributor for evenly distributing the ground, beverage-making substance in the compartment by rotation of the distributor when in contact with the ground, beverage-making sub stance;
a tamper for tamping the ground, beverage-making substance subsequent to the distributor evenly distributing the ground, beverage-making substance by moving the tamper in a tamping direction, preferably downwards, and applying pressure on the ground, beverage-making substance; and
at least one driving means, such as a motor, a handle or an actuator, for driving the rotation of the distributor and tamping movement and pressing of the tamper, or at least one driving means for driving the rotation of the distributor and at least one other driving means for driving the tamping movement of the tamper and the pressing of the compartment by the tamper, wherein the tamper and the distributor are directly or indirectly attached to one another in an operative state and that in the operative state the tamper and the distributor are concentrically arranged and are configured to be brought into contact with the ground, beverage-making substance from the same direction, preferably from above, during normal operation.

16. The device according to claim 15, wherein a lower surface pressing the ground, beverage-making substance during tamping is essentially an even surface, perpendicular to the tamping direction and preferably horizontal.

17. The device according to claim 15, wherein the tamper has at least one groove, indent or hole configured to fit with at least one part of the distributor and that during tamping operation the tamper moves so at least one part of the distributor moves into the at least one part of the tamper.

18. The device according to claim 15, wherein the device further comprises contacting means for contacting the compartment containing the ground, beverage making substance.

19. The device according to claim 15, wherein the device further comprises a locking device that releasably locks the distributor and tamper when the tamper reaches a designated lowest position representing the desired level of tamping of the ground, beverage making sub stance.

20. The device according to claim 19, wherein the device further comprises a handle suitable for human grip and a locking mechanism actuator for at least one of locking and unlocking the locking device, where the locking mechanism actuator is positioned in such a way that it is easily be reached by one or more fingers without substantially releasing the grip on the handle suitable for human grip.

21. The device according to claim 15, wherein the device further comprises an adjusting device configured to adjust how hard the tamper tamps the ground, beverage making substance held in the compartment.

22. The device according to claim 21, wherein the adjusting device is configured to adjust how hard the tamper tamps the ground, beverage making substance held in the compartment, and to adjust how far in the tamping direction and into the compartment the tamper goes when tamping.

23. The device according to claim 22, wherein adjusting how far in the tamping direction and the into the compartment the tamper goes when tamping is done by adjusting a height difference between the distributor/tamper in the compressed position and the bottom of the portafilter.

24. The device according to claim 15, wherein the distributor is mounted on an axle.

25. The device according claim 15, wherein the one or more driving means is also directly or indirectly attached to the tamper and distributor in the operative state.

26. The device according claim 15, wherein the device is part of a larger machine that also grinds the ground, beverage making substance and/or passes liquid under pressure through the ground, beverage-making substance.

27. The device according to claim 15, wherein in the liquid is water and the ground, beverage making substance is ground coffee beans.

28. A method for making a beverage, particularly espresso, the method comprising:
passing liquid under pressure through a ground beverage-making substance, particularly coffee, held in a compartment such as a filter, portafilter or strainer;
distributing, by a distributor, the ground, beverage-making substance in the compartment by rotation of the distributor when in contact with the ground, beverage-making substance;
tamping, by a tamper, the ground, beverage-making substance subsequent to the distributing of the ground, beverage-making substance by moving the tamper in a tamping direction, preferably downwards, and applying pressure on the ground, beverage-making substance; and
driving, by at least one driving means, the rotation of the distributor and tamping movement and pressing of the tamper, or driving, by at least one driving means the rotation of the distributor and driving, by at least one other driving means, the tamping movement of the tamper and the pressing of the compartment by the tamper,
wherein the tamper and the distributor are directly or indirectly attached to one another in an operative state and that in the operative state the tamper and the distributor are concentrically arranged and are configured to be brought into contact with the ground, beverage-making substance from the same direction, preferably from above, during normal operation.
